(19) United States
(12) Patent Application Publication
(10) Pub. No.: US 2006/0169557 A1
(43) Pub. Date: Aug. 3, 2006

(54) Constrained layer viscoelastic laminate tuned mass damper and method of use

(75) Inventor: Gregory M. Goetchius, Oakland, MI (US)

Correspondence Address: Quinn Law Group, PLLC., 39555 Orchard Hill Place, Suite # 520, Novi, MI, 48375, US

(73) Assignee: Material Sciences Corporation

(21) Appl. No.: 11/048,602

(22) Filed: Feb. 1, 2005

(51) Int. Cl. F16F 7/10

(52) U.S. Cl. 188/378

(57) ABSTRACT

The present invention is a “beam type” tuned mass damper (TMD) having beams of constrained layer viscoelastic laminate material affixed to a mounting base or directly to the host structure and a method of use. The “beam type” TMD of the present invention is able to damp several frequencies by combining beams of varying characteristics to the mounting base, such as by changing the geometrical or material properties of the constraining layers and the viscoelastic layer of the constrained layer viscoelastic laminate.

### TECHNICAL FIELD

The present invention relates to the damping of a vibrating host structure at targeted resonance points, by the use of a tuned mass damper made from beams of constrained layer viscoelastic laminate material.

### BACKGROUND OF THE INVENTION

The need to damp unwanted vibrations is a common problem experienced in the mechanical arts. Vibration cancellation techniques can generally be placed into two groups, active vibration cancellation and passive vibration cancellation. Passive vibration cancellation is the most commonly used as it is the simplest and most cost effective solution to implement. One such passive device is the tuned mass damper, or TMD as it is commonly referred to in the art. The TMD is an effective means for reducing unwanted resonant vibrations in structures.

Typical TMDs are constructed from a combination of rubber and a mass of steel or lead. The rubber acts as a spring as well as providing a measure of damping to the system, and the mass increases the energy that can be absorbed by the TMD. The spring rate of the rubber, and the mass of the weight determine the resonant frequency of the system. This is the frequency to which the system is tuned. In addition to the mass and rubber components, there are often additional fasteners and mounts required to assemble and attach the TMD to the host structure.

In its elemental form, the TMD consists of a mass, spring, and a dashpot. The spring and dashpot are connected in parallel to the mass. A TMD is a single degree of freedom resonant system. When mounted to a rigid base, the properties of the TMD can be characterized by the following equations:
Natural Frequency=\sqrt{k/m}
where (k) is the spring stiffness and (m) is the mass

$$Damping Ratio = \frac{c}{( 2 * \sqrt{( km )} )}$$

where (k) is the spring stiffness, (m) is the mass, and (c) is the damping coefficient.

The spring stiffness (k) and mass (m) should be chosen to place the natural frequency of the TMD approximately equal to or slightly less than the frequency to be damped in the host structure. This so-called “target” mode of the host structure is thusly replaced by two modes, with one mode slightly above and one mode slightly below the original resonant mode of the structure. These “split modes” are then damped by the dashpot or damping element of the TMD. In effect, the TMD converts the vibrational energy of the target mode into heat.

The damping effectiveness of the TMD is highly dependent on the damping ratio. A damping ratio of 20 to 30 is an effective range for a TMD. Preferably, the TMD would be placed on the host structure at the point where the amplitude of oscillation is greatest.

A limitation of the conventional TMD is that it is a narrow band device. The TMD will only damp modes with natural frequencies close to that of the TMD. Therefore, if the frequency range to be damped of the host structure is very large, multiple TMDs will be required to effectively damp the structure. The additional TMDs may increase the cost and complexity in the mechanical system. Also, the additional space required for the conventional TMDs may not be available for structures that have already been designed and built. A conventional TMD is costly to produce since it must be manufactured from its constituent parts. In addition, manufacturing variations within the constituent parts may affect the tuning frequency of the TMD, resulting in ineffective damping of the host structure.

### SUMMARY OF THE INVENTION

In view of the foregoing, the present invention provides an improved TMD that is compact, simple, and cost effective. Furthermore, the present invention provides a TMD that is capable of damping multiple frequencies.

The present invention is a “beam type” TMD constructed by affixing a beam or plurality of beams formed from a constrained layer viscoelastic laminate material to a mounting base or, alternately, directly affixing the beams to the host structure that is to be damped. The constrained layer viscoelastic laminate material is formed from at least two constraining layers with at least one viscoelastic layer disposed therebetween. The present invention dispenses with the traditional mass, spring, and dashpot configuration and instead substitutes a beam of constrained layer viscoelastic laminate material. The mass element of the present invention is considered to be the sum of the mass of the constraining layers and that of the viscoelastic layer. Since the “beam type” TMD will only be operable in the purely elastic region, the spring element of the present invention is the elasticity of the constraining layers and to a lesser extent the viscoelastic layer. The damping element of the present invention is the constrained viscoelastic layer.

Damping is achieved when, through vibration induced flexural motion of the beam, shear strains develop in the constrained viscoelastic layer. This vibrational energy is thusly converted into heat by the constrained viscoelastic layer. It should be noted that the word “beam” can encompass any shape and is not meant to limit the scope of this invention.

The “beam type” TMD can damp several different frequencies of the host structure. The “beam type” TMD has an infinite number of natural frequencies for each respective bending mode of the beam. However, with higher order bending modes, the effectiveness of the “beam type” TMD may be diminished due to a decrease in the modal mass. Therefore, the present invention also provides a structure operable to effectively damp many additional frequencies of the host structure by the addition of beams of varying configurations to the mounting base. This effect is achieved by changing the geometry or material properties of either the constraining layers or the viscoelastic layer or both. For example, two beams of the same laminate material but of differing lengths can effectively damp two different frequencies for each bending mode of the beams.

To assemble the present invention, one need only mount or affix the beams to the mounting base by mechanical or adhesive bonding means. The beams of the present invention may also be mounted directly to the host structure if the design of the host structure will permit. A secondary mass may also be provided at any point along the beam to increase the modal mass of the “beam type” TMD The ease of manufacturing and decrease in piece count may yield an inexpensive alternative to conventional TMDs. The present invention is scalable, meaning that the TMD may be made in any size depending on the structure to be damped. A very large TMD of the present configuration could be used to damp vibrations in bridges while a small TMD of the present configuration may be used to damp the brake assembly or steering column of an automobile.

Accordingly, the present invention is a tuned mass damper having a mounting base adapted for mounting to a movable host structure and at least one beam mounted or affixed to the mounting base. The beam must extend sufficiently therefrom to absorb the kinetic energy resulting from vibratory movement of the host structure to which the mounting base is affixed. If the host structure will permit, the constrained layer viscoelastic laminate beam may be directly mounted to the host structure thereby dispensing with the mounting base. The beam is constructed of a constrained layer viscoelastic laminate. In the preferred embodiment, the constrained layer viscoelastic laminate material will consist of at least one viscoelastic layer constrained by at least two steel constraining layers. The beam in the present invention can be any geometric shape such as a flat rectangular structure, an accordion or z-shape, a circular plate, or a spiral spring shape. Secondary masses may also be added to the beam at either the free end or along the beam to increase the modal mass of the tuned mass damper.

The present invention also provides a method of damping vibrations within a structure by mounting or affixing a tuned mass damper to the host structure to be damped. The tuned mass damper having a mounting base adapted for mounting to a movable host structure and at least one beam mounted or affixed to the mounting base and extending sufficiently therefrom to absorb the kinetic energy occasioned by vibratory movement of the host structure to which the mounting base is mounted or affixed. In the preferred embodiment, the beams of the tuned mass damper will be made from a viscoelastic layer constrained by layers of steel. If the design of the host structure will permit, the beam or beams may be mounted directly to the structure thereby dispensing with the mounting base.

The present invention is also adaptable to damp multiple frequency vibrations within a host structure through the addition of a plurality of beams made from constrained layer viscoelastic material to the mounting base of the tuned mass damper, wherein each of the beams may have different geometrical or material properties for either the constraining layers or the viscoelastic layer. In the preferred embodiment, the beams of the tuned mass damper will be made from a viscoelastic layer constrained by layers of steel.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram illustrating a traditional TMD with a single degree of freedom;

FIG. 2 is a graphical illustration of “mode splitting”;

FIG. 3 is a schematic side view of a first embodiment of the “beam type” TMD of the present invention illustrating the various elements of the invention;

FIG. 4 is a schematic side view of a second embodiment of the “beam type” TMD with unequal length beams illustrating the various elements of the invention;

FIG. 5 is a schematic top view of a third embodiment of the “beam type” TMD illustrating a four beam configuration;

FIG. 6 is a schematic side view of a fourth embodiment of the “beam type” TMD illustrating a beam of constrained layer viscoelastic laminate material mounted or affixed directly to the host structure with a secondary weight attached to increase the modal mass of the “beam type” TMD;

FIG. 7 is a schematic side view of a fifth embodiment of the “beam type” TMD illustrating a z-shaped or accordion shaped beam of constrained layer viscoelastic laminate material;

FIG. 8 is a schematic plan view of a sixth embodiment of the “beam type” TMD of the present invention illustrating a circular disk of constrained layer viscoelastic material; and

FIG. 9 is a schematic bottom view of a seventh embodiment of the TMD of the present invention illustrating a spiral spring shaped beam of constrained layer viscoelastic laminate material.

### DESCRIPTION OF THE PREFERRED EMBODIMENTS

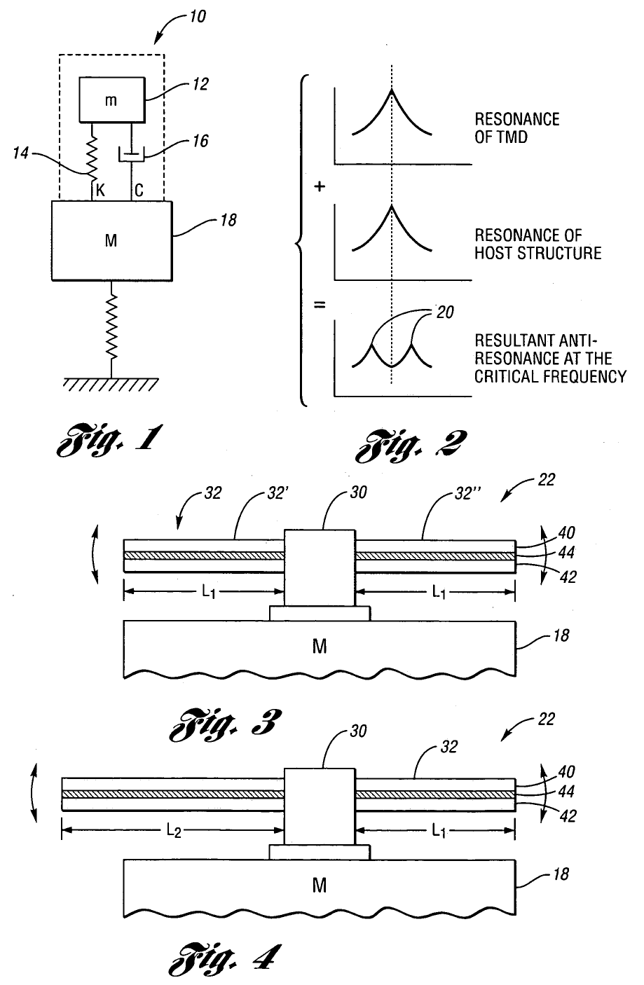

Referring to the drawings, FIG. 1 illustrates a conventional TMD 10. This TMD 10 consists of a mass 12, spring 14, and a dashpot 16. The spring 14 and dashpot 16 are connected to the mass 12 and host structure 18 in parallel. The spring 14 has a spring stiffness (k), and mass 12 has a mass of (m). These variables should be chosen in order to place the natural frequency of the TMD 10 approximately equal to, or just below the frequency or mode to be damped in the host structure 18 according to the following equation:
Natural Frequency=\sqrt{k/m}
where (k) is the spring stiffness and (m) is the mass of the weight.

The “target” mode of host structure 18 is thusly replaced by two modes, with one mode slightly above and one mode slightly below the original resonance mode of the host structure 18 with an anti-resonance being created at the critical frequency. These “split modes” 20, shown in FIG. 2, are then damped by the dashpot 16 of the TMD 10. In effect, the TMD 10 converts the vibrational energy of the of the target mode into heat. Typically, the conventional TMD 10 has a large “footprint” and can only damp a single frequency.

FIG. 3 schematically illustrates one embodiment of the present invention. The “beam type” TMD 22 consists of a mounting base 30 that may be mounted or affixed to the host structure 18 by any mechanical means, such as rivets, bolts, interference fits, welding, screws, clamps, or pins, or it may be applied by bonding, such as glues or epoxies. Attached to this mounting base 30 may be one beam 32 or a plurality of beams 32′, 32″. The beams 32 may have differing shapes, such as rectangular, triangular, rounded, etc. The mounting base 30 may be any geometric configuration, such as, a square or rectangular box, hemisphere, cylinder, or post. Beams 32 may be affixed to the mounting base 30 by any mechanical means, such as rivets, bolts, interference fits, welding, screws, clamps, or pins, or they may be applied by bonding, such as glues or epoxies. The beams 32 may also be directly mounted or affixed to the host structure that is to be damped, as shown in FIG. 6, thereby obviating the need for the mounting base 30.

The beams 32 are constructed from constrained layer viscoelastic laminate material. The constraining layers 40, 42 may be made from any material that will provide the necessary stiffness to the viscoelastic layer 44 for the specific application; such as steel, aluminum, stainless steel, magnesium, composites, or plastics. The preferred material in the present invention is steel due to its low cost and exceptional fatigue life. The preferred laminate structure is available from Material Sciences Corporation of Elk Grove Village, Ill. under the trade name Quiet Steel®.

The present invention dispenses with the traditional mass 12, spring 14, and dashpot 16 configuration that is shown in FIG. 1. The mass element of the “beam type” TMD 22 is considered to be the sum of the mass of the constraining layers 40,42 and that of the viscoelastic layer 44. Since the “beam type” TMD 22 will only be operable in the purely elastic region, the spring element of the present invention is the elasticity of the constraining layers 40, 42 and to a lesser extent the viscoelastic layer 44. The damping element of the present invention is the viscoelastic layer 44. This damping occurs when, through vibration induced flexural motion of the beam 32, shear strains develop in the viscoelastic layer 44. This vibrational energy is thusly converted into heat by the viscoelastic layer 44.

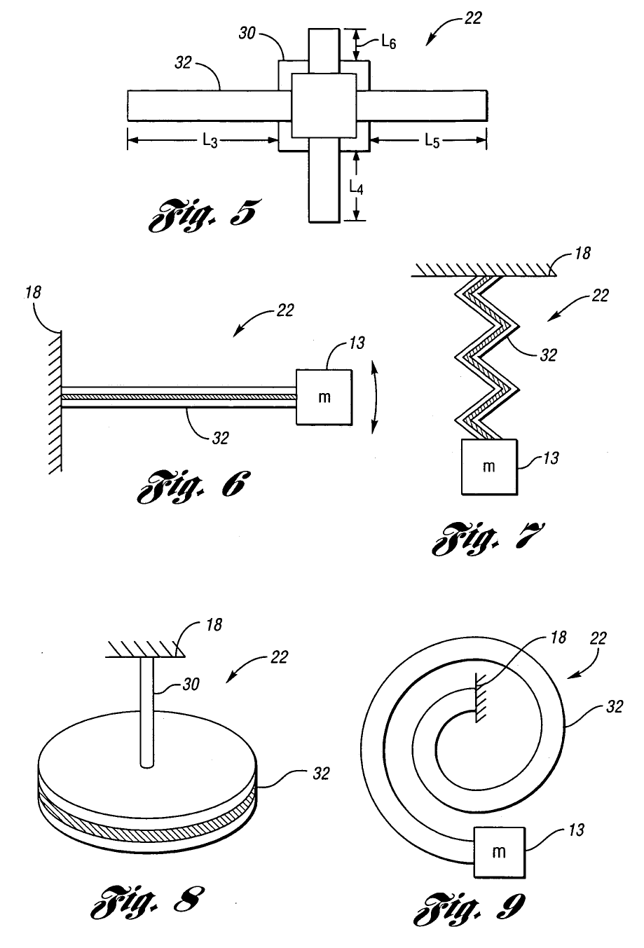

The conventional TMD 10 can only effectively damp one frequency. The “beam type” TMD 22 can damp several different frequencies of the host structure 18. The “beam type” TMD 22 has an infinite number of natural frequencies for each respective bending mode of the beam 32. However, with higher order bending modes, the effectiveness of the “beam type” TMD 22 may be diminished due to a decrease in the modal mass. Therefore, the present invention also provides a structure operable to effectively damp many additional frequencies of the host structure 18 by the addition of beams of varying configurations to the mounting base. This effect is achieved through altering the geometrical or material properties of either the constraining layers 40, 42 or the viscoelastic layer 44 or both. For example, a mounting base 30 with two different length beams L₁ and L₂ of the same material, as shown in FIG. 4, may effectively damp two different frequencies for each bending mode of the beams 32. FIG. 5 illustrates a plurality of four beams 32, extending outward from the mounting base 30 for differing lengths L₃, L₄, L₅, and L₆. This configuration is effective at damping four different frequencies for each bending mode of beams 32. The beam 32 of the present invention can be tuned for the proper frequency by varying the length, width, shape, or configuration of the beam 32 or by changing the material properties of the viscoelastic layer 44 or the constraining layers 40, 42. In addition, the constraining layers 40, 42 may each be of a different material.

Exemplary of this invention, one of the most important parameters to be considered is the total mass of the TMD. There must be sufficient “modal mass’ of the TMD, relative to the mass of the host structure to which the TMD is attached to realize the desired tuning effect. A rule for TMD tuning is that the modal mass of the TMD should be 10% of the modal mass of the host structure. For example, if one were developing a TMD for use on a steering wheel to counteract the effect of the vertical bending resonance of the steering column, one would need a TMD with a modal mass of approximately 0.5 Kg since the modal mass of a typical steering column as measured during the primary bending mode is approximately 5 Kg. The mass also determines the frequency at which the system is tuned, therefore, the dimensions and material properties of beams 32 must be carefully designed to provide the correct stiffness and mass to achieve the desired tuning effect.

FIG. 6 illustrates a beam 32 directly mounted to the host structure 18 with a secondary mass 13 attached at the free end. This secondary mass 13 may be used to increase the modal mass of the ‘beam type” TMD 22 should the mass of the beam 32 prove insufficient to allow for effective damping of the host structure 18. This secondary mass 13 may also be placed at any point along beam 32.

Many alternatives exist for the creation of a “beam type” TMD 22 utilizing a constrained layer viscoelastic laminate material. In addition to the straight beam configuration discussed above, one could create a “beam type” TMD 22 with a Z-shaped or accordion shaped strip as shown in FIG. 7, a circular disk rigidly mounted to the host structure to allow bending motion at the periphery as shown in FIG. 8, or a spiral spring shaped beam as shown in FIG. 9. Any of these alternative geometries may have a secondary mass 13 mounted at any point along the beam to increase the modal mass of the “beam type” TMD 22. The geometry of the beam 32 would ultimately be determined by the need to maximize the shear strain energy transmitted to the viscoelastic layer 44 as well as the packaging requirements of the host structure. All of the embodiments for beams 32 may be made from the previously referenced Quiet Steel®. The ease of manufacturing and decrease in piece count makes the “beam type” TMD 22 a potentially lower cost alternative to a conventional TMD 10.

While the best modes for carrying out the invention have been described in detail, those familiar with the art to which this invention relates will recognize various alternative designs and embodiments for practicing the invention within the scope of the appended claims.

We claim:

1. A “beam type” tuned mass damper structure comprising:
at least one beam mounted to a host structure and extending sufficiently therefrom to absorb the kinetic energy occasioned by vibratory movement of said host structure to which said beam is mounted, said beam being made from constrained layer viscoelastic laminate material, having at least two constraining layers and at least one viscoelastic layer disposed between said constraining layers.

2. The tuned mass damper structure of claim 1, including a mounting base member adapted for mounting to said host structure wherein said at least one beam is mounted to said host structure through attachment to said mounting base member.

3. The tuned mass damper structure of claim 1, wherein said at least one beam is mounted directly to said host structure.

4. The tuned mass damper structure in claim 1, wherein said at least two constraining layers are each made from a different material.

5. The tuned mass damper structure in claim 1, wherein said at least two constraining layers are each made from a steel.

6. The tuned mass damper of claim 1 wherein said at least one beam is accordion or z-shaped.

7. The tuned mass damper of claim 1, wherein said at least one beam is a circular disk.

8. The tuned mass damper of claim 1, wherein said at least one beam is spiral in shape.

9. The tuned mass damper of claim 1, wherein said at least one beam has a free end and a secondary mass mounted to said free end of said at least one beam operable to increase the modal mass of said tuned mass damper.

10. The tuned mass damper of claim 1, wherein said at least one beam a secondary mass mounted along said at least one beam operable to increase the modal mass of said tuned mass damper.

11. The tuned mass damper of claim 1, wherein the mounting is by attachment.

12. The tuned mass damper of claim 11, wherein the mounting is by adhesive bonding.

13. The tuned mass damper of claim 11, wherein the mounting is by mechanical attachment.

14. A method of damping vibrations within a host structure comprising:
mounting a tuned mass damper to a said host structure, wherein said tuned mass damper includes:
at least one beam mounted to said host structure and extending sufficiently therefrom to absorb the kinetic energy occasioned by vibratory movement of said host structure to which said at least one beam is mounted, said at least one beam being made from constrained layer viscoelastic laminate material.

15. The method of damping vibrations of claim 14, wherein said at least one beam is mounted to said host structure through attachment to a mounting base member adapted for mounting to said host structure.

16. The method of damping vibrations of claim 14, wherein said at least one beam is mounted directly to said host structure.

17. A “beam type” tuned mass damper structure capable of damping multiple frequencies comprising:
a mounting base member adapted for mounting to a movable host structure; and
a plurality beams mounted to said mounting base member and extending sufficiently therefrom to absorb the kinetic energy occasioned by vibratory movement of said host structure to which said plurality of beams are mounted, at least some of said plurality of beams having respectively different geometries or material properties so as to adjust each of their respective natural frequencies to be equal to or slightly less than a respective one of the vibrational frequencies of said host structure to be damped, said plurality of beams being made from constrained layer viscoelastic material having at least two constraining layers and at least one viscoelastic layer disposed between said constraining layers.
